(19) United States
(12) Patent Application Publication
(10) Pub. No.: US 2014/0351603 A1
(43) Pub. Date: Nov. 27, 2014

(54) ENCRYPTION PROCESS PROTECTED AGAINST SIDE CHANNEL ATTACKS

(71) Applicant: INSIDE SECURE, Meyreuil (FR)

(72) Inventors: Benoît Feix, Aubagne (FR); Mylène Roussellet, Aix en Provence (FR)

(21) Appl. No.: 14/371,049

(22) PCT Filed: Dec. 21, 2012
(86) PCT No.: PCT/FR2012/000546

§ 371 Date: Jul. 8, 2014

(30) Foreign Application Priority Data
Jan. 11, 2012 (FR) 12 50272

(51) Int. Cl. G06F 21/72; H04L 9/06

(52) U.S. Cl. CPC G06F 21/72; H04L 9/0625
USPC 713/189

(57) ABSTRACT

The invention relates to a symmetric encryption process executed by a microcircuit to transform a message into an encrypted message from a secret key, the process including a first round, intermediary rounds, and a last round. According to the invention, the process includes several executions of the first round and of the last round, and a number of executions of at least one intermediary round, the number of executions being less than the number of executions of the first and last rounds. The invention is particularly applicable to DES, Triple DES, and AES processes.

The present invention relates to a block encryption process executed by a microcircuit and protected against side channel attacks, to transform a message into an encrypted message using a secret key.

In particular, the present invention relates to integrated circuit chipcards or the material cryptographic components integrated on computer motherboards or other general public electronic and computing equipment requiring security means (USB keys, television channel decoders, game consoles, etc.), known as “TPM” (Trusted Platform Module).

Such microcircuits are equipped with a CPU (central processing unit) that generally comprises an 8-bit CISC core or an 8, 16, or 32 bit RISC core. Certain microcircuits are equipped with a coprocessor dedicated to cryptographic calculations, for example a DES (Data Encryption Standard) or AES (Advanced Encryption Standard) coprocessor. They comprise thousands of logic gates that switch differently depending on the operations executed. These switchings create measurable short duration, for example only several nanoseconds, current consumption variations. In particular, CMOS technology circuits comprise logic gates that consume current only during their switching, corresponding to being a logic node being set to a 0 or a 1. Thus, the current consumption depends on the data processed by the CPU and by its various peripherals: memory, data traveling on the data or address bus, cryptographic coprocessor, etc.

Such microcircuits are subjected to attacks called side channel attacks, based on a monitoring of their current consumption, their magnetic emissions, or electromagnetic emissions. Such attacks aim to discover the secret data used, in particular the cryptographic keys. The most widely used side channel attacks implement statistical analysis methods such as DPA (“Differential Power Analysis”) or CPA (“Correlation Power Analysis”). DPA allows the key of a cryptographic algorithm to be found thanks to the acquisition of numerous circuit consumption curves. CPA is based on a linear current consumption model and consists of calculating a correlation coefficient between, on one hand, the consumption points measured which form the captured consumption curves, and on the other hand, an estimated consumption value, calculation from the linear consumption model and a hypothesis about the operation executed by the microcircuit and the cryptographic key value.

Countermeasures are generally provided in order to protect such microcircuits and the encryption methods that they perform against such side channel attacks. Masking and multiple-execution are the most commonly implemented countermeasures. A masking countermeasure uses a random mask (binary number) combined with the key and/or the message during the execution of the encryption process. This type of countermeasure is efficient but requires, in the case of execution by a coprocessor, that the coprocessor specially be provided for its implementation, or, in the case of execution by the microcircuit CPU, a more complex program.

A multiple-execution countermeasure may, on the contrary, be implemented with a conventional coprocessor not comprising countermeasure means. It comprises simply executing the encryption process several times with false keys. To this end, a countermeasure program is provided for example. The program controls the encryption program or the coprocessor, and makes it execute the encryption process several times with the false keys, such that the execution of the encryption process with the true key (i.e. the authentic key) is “lost” in a sea of misleading executions.

The present invention relates particularly to multiple-execution countermeasures applied to symmetric type block encryption methods, such as the DES, TDES, and AES processes. These conventional countermeasures will be better understood after a review of the structures of these encryption methods.

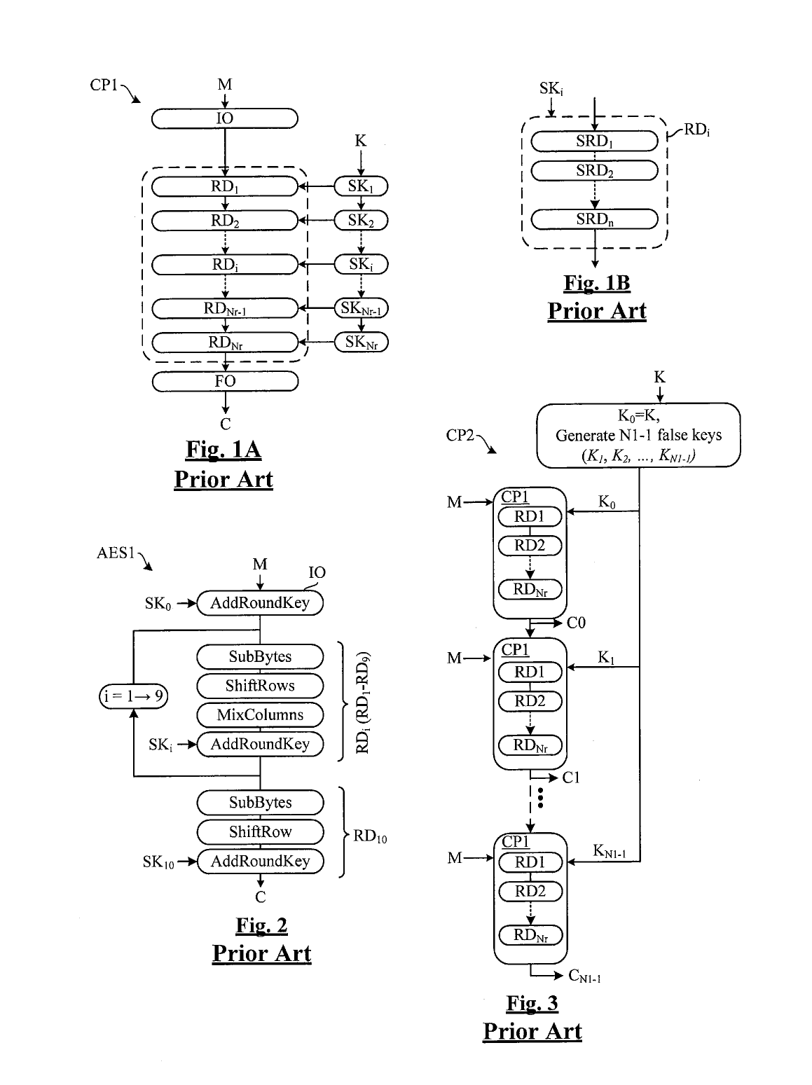

FIG. 1A schematically shows the architecture of a block encryption process CP1. The process is symmetrical, which means that it uses the same secret key for the encryption and for the decryption. The process receives a message M and a secret key K on input, and supplies an encrypted message C. It comprises Nr rounds RD₁, RD₂ . . . RDᵢ . . . RD_{Nr-1}, RD_{Nr} successively executed. Between the first round RD₁ and the last round RD_{Nr}, the process comprises intermediary rounds RD₂ . . . RDᵢ . . . RD_{Nr-1}. The process may also comprise an initial operation IO aiming to prepare the message by means of a first transformation function before rounds are executed, and a final operation FO aiming to transform the result of the last round by means of a second transformation function to obtain the encrypted message C.

Each round RDᵢ (i being considered here as an index from 1 to Nr) generally uses a sub-key SKᵢ derived from the key K or derived from the sub-key used by the preceding round. Each round supplies to the following round an intermediary secret result that is not accessible to an attacker, this result being for example temporarily stored in a protected memory. Thus, the first round RD₁ receives the message M or a data issued by the transformation of the message by the initial operation IO as input data, and supplies a first secret intermediary result to the next round RD₂. Each intermediary round RDᵢ receives the secret intermediary result supplied by the preceding round as input data, and supplies a secret intermediary result to the next round. The last round receives the secret intermediary result supplied by the next-to-last last round RD_{Nr-1} as input data, and supplies a final result forming the encrypted message C or forming the encrypted message after transformation by the final operation FO.

The number of rounds is predetermined by standards, and is for example equal to 16 in the case of the DES process, 48 in the case of the TDES process, 10 in the case of the AES 128 process, 12 in the case of the AES 192 process, and 14 in the case of the AES 256 process. Similarly, the standards define the structure of the rounds, that is to say, the encryption operations that they comprise. As schematically shown in FIG. 1B, each round RDᵢ generally comprises sub-rounds SRD1, SRD2 . . . SRDₙ. For example, each round RDᵢ of the DES process comprises four sub-rounds ExpansivePermutation, Exclusive OR, Substitution, and Permutation.

As another example, FIG. 2 shows a conventional structure of an AES encryption process in the form of a flowchart “AES1”. The process comprises: an initial operation IO comprising the operation “AddRoundKey” using a first sub-key SK₀; nine rounds RDᵢ (RD₁ to RD₉) using nine other sub-keys SKᵢ and each comprising four sub-rounds “SubBytes”, “ShiftRows”, “MixColumns”, and “AddRoundKey”; and a last round RD₁₀ comprising three sub-rounds “SubBytes”, “ShiftRow”, and “AddRoundKey” using a tenth sub-key SK₁₀.

FIG. 3 schematically shows an example of a process CP2 protected against side channel attacks by the multiple execution technique. The process comprises an initial step of generating N1-1 false keys K₁, K₂ . . . K_{N1-1}, the true key K being for example key K₀. Process CP2 comprises N1 executions of the process CP1 of FIG. 1. Process CP1 is executed a first time with key K₀, then with the first false key K₁, then with the second false key K₂, etc. until the N1^{th} execution with the false key K_{N1-1}. Each execution supplies a result C₀, C₁ . . . C_{N1-1} from the corresponding key and the message M. Only one of these results is valid and the others are false. The order in which the keys are used is random (the regular order shown in FIG. 3 being merely an example) such that an attacker does not know which execution uses the true key.

This solution nevertheless has the inconvenience of penalizing the execution time of the encryption process. The multiple executions of the encryption process CP1 greatly slow down the time to supply the result, even when a rapid processor or coprocessor is provided. Thus, for example when N1=8, the countermeasure requires the execution of 128 rounds for a DES process and 384 rounds for a TDES process. If N1=32, the countermeasure requires the execution of 512 rounds for a DES process and 1536 rounds for a TDES process.

It may therefore be desired to provide an encryption process including a multiple-execution countermeasure that requires less calculation time all while offering a good protection against side channel attacks.

More particularly, embodiments of the invention relate to a symmetric encryption process executed by a microcircuit to transform a message into an encrypted message from a secret key, comprising a first round, intermediary rounds, and a last round, the process further comprising several executions of the first round and of the last round, respectively from the secret key and from a first set of false keys, and a number of executions, of at least one intermediary round less than the number of executions of the first and last rounds, respectively from the secret key and from a set of false keys included in the first set of false keys.

According to one embodiment, the process comprises a second round, a next-to-last round, and several intermediary rounds, wherein the first two rounds are executed a greater number of times than the intermediary rounds, and the last two rounds are executed a greater number of times than the intermediary rounds.

According to one embodiment, the process comprises only one execution of the at least one intermediary round.

According to one embodiment, the process comprises for a determined number of rounds successive from the first, a number of round executions of decreasing according to a decreasing rule that is a function of the rank of rounds considered relative to the first round, then for a determined number of successive rounds until the last, a number of round executions increasing according to an increasing rule that is a function of the rank of rounds considered relative to the last round.

According to one embodiment, the decreasing rule is of 1/(2ⁿ), n being a parameter of function of rank of rounds considered relative to the first or to the last round.

According to one embodiment, each round comprises sub-rounds, and wherein the multiple execution of each round comprises the multiple execution of each sub-round of the round.

According to one embodiment, each round comprises sub-rounds, and wherein the multiple execution of a round comprises the multiple execution of at least one sub-round, and a single execution of at least one other sub-round.

According to one embodiment, the single execution of the sub-round is a single or higher order masked execution.

According to one embodiment, the multiple execution of the sub-round is a single order masked execution.

According to one embodiment, the process is in conformance with the DES, triple DES, or AES specifications.

Embodiments of the invention also relate to a microcircuit configured to execute a symmetric encryption process to transform a message into an encrypted message from a secret key, the process comprising a first round, intermediary rounds, and a last round, and the microcircuit is configured to execute several times the first round and the last round, respectively from the secret key and from a first set of false keys, and to execute at least one intermediary round a number of times less than the number of executions of the first and last rounds, respectively from the secret key and from a set of false keys included in the first set of false keys.

According to one embodiment, the microcircuit is configured to execute the at least one intermediary round only once.

According to one embodiment, the microcircuit is configured to execute rounds comprising sub-rounds, and to execute, during a multiple execution of a round, all the sub-rounds of the round the same number of times.

According to one embodiment, the microcircuit is configured to execute rounds comprising sub-rounds, and to execute, during a multiple execution of a round, at least one sub-round only once and to execute another sub-round several times.

According to one embodiment, the microcircuit comprises a modular coprocessor configured to execute individually encryption operations comprised in sub-rounds.

Embodiments of encryption methods and of a microcircuit according to the invention will be described in the following in non-limiting reference to the appended drawings, among which:

FIG. 1A, previously described, shows the structure of a conventional encryption process by rounds,

FIG. 1B, previously described, show the structure of a round of the process of FIG. 1,

FIG. 2, previously described, shows the structure of a conventional AES encryption method,

FIG. 3, previously described, shows the structure of a conventional encryption process protected against side channel attacks,

FIG. 4 shows the structure of an encryption process according to an embodiment of the invention,

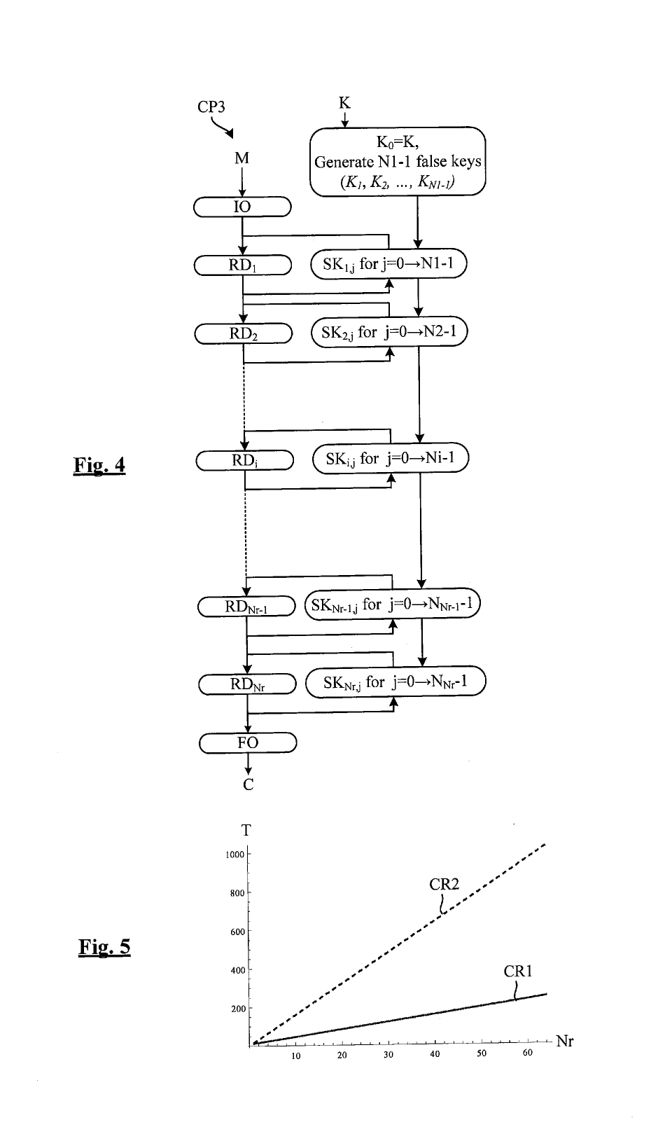

FIG. 5 shows an advantage of the process of FIG. 4,

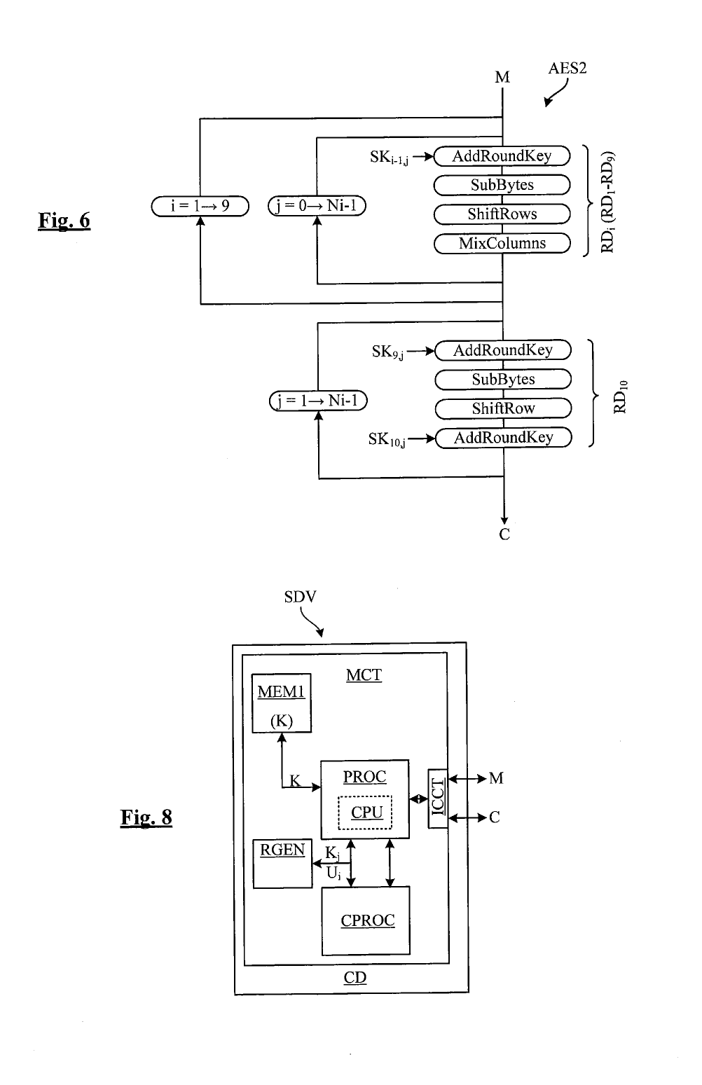

FIG. 6 shows the structure of an AES encryption process according to the invention,

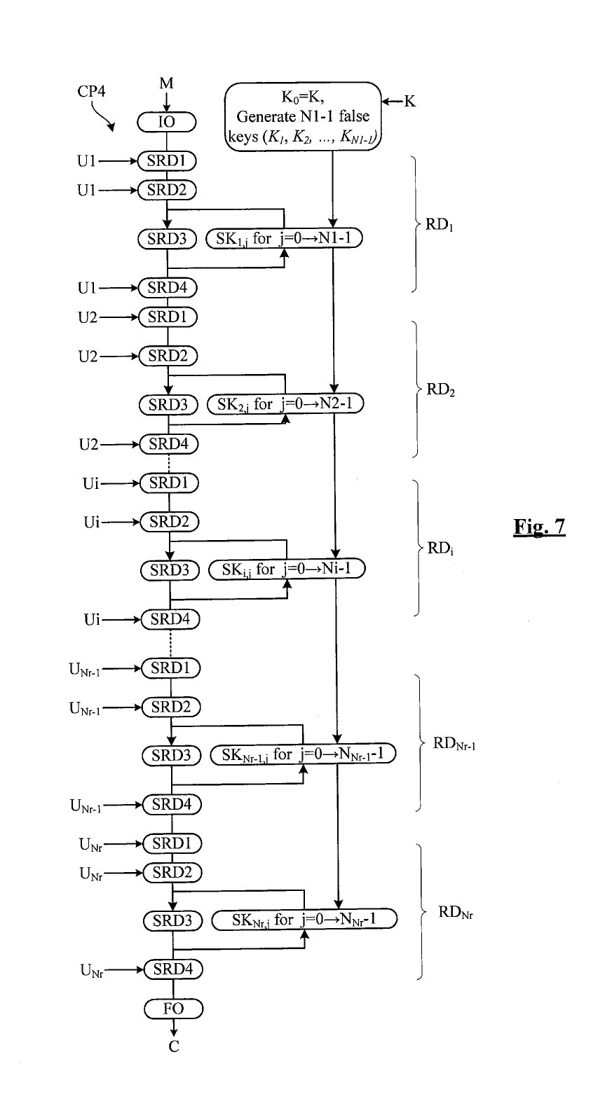

FIG. 7 shows the structure of another embodiment of an encryption process according to the invention, and

FIG. 8 shows an embodiment of a secure microcircuit according to the invention.

Embodiments of the invention are based on the observation that not all rounds of a symmetric encryption process require the same level of protection against side channel attacks. The first and last rounds are the most exposed (i.e. the most vulnerable) to this type of attack, and notably to DPA or CPA attacks. Indeed, DPA or CPA can only be carried out against a round if input or output data of the round is known to the attacker, the key being the object of the attack.

And yet, in reference to FIG. 1A previously described, the first round RD₁ receives input data that is known to an attacker. It consists of message M or a data resulting from the transformation of the message by the initial operation IO. As the initial operation is also known to the attacker since it is described by the applicable standards, the input data may be calculated from the message if it is not the message itself. Similarly, the last round RD_{Nr} supplies a result known to the attacker. It consists of the encrypted message C or of data from which the encrypted message C has resulted, after transformation of the data by the final operation FO. As the final operation is equally known to the attacker, this data may be found from the encrypted message C, by means of the inverse function of the function used by the final operation FO. Therefore, an attack on the intermediary rounds, in particular from the third round to the next-next-to-last round, is of too great a complexity to be currently envisaged without a preliminary attack on the first two or last two rounds.

Embodiments of the invention thus relate to an encryption process in which the number of intermediary round RDᵢ (RD₂, RD₃ . . . RDᵢ, RD_{Nr-1}) executions is less than the number of the first round and last round executions, in order to reduce the total number of round executions and to reduce the total execution time of the encryption process. In some embodiments, the second and the next-to-last rounds RD₂, RD_{Nr-1} are considered as more exposed to attacks than other intermediary rounds, and are executed a greater number of times than the other intermediary rounds. In yet other embodiments, “central” intermediary rounds (i.e. those that are the farthest from the first and last rounds) are only executed once.

By way of example, FIG. 4 schematically shows the structure of a block encryption process CP3 according to the invention, of the symmetric type, protected against side channel attacks. In a manner that is in and of itself conventional, the process supplies an encrypted message C, from a message M and a secret key K, and comprises Nr rounds RD₁, RD₂ . . . RDᵢ . . . RD_{Nr-1}, RD_{Nr}. The process may comprise an initial operation initial 10 aiming to prepare the message M before the execution of rounds, and a final operation FO aiming to transform the result of the last round by means of the known transformation function to obtain the encrypted message C. It equally comprises an initial step of generating N1-1 false keys K₁, K₂ . . . K_{N1-1} besides the secret key K. Key K is for example considered as the key of rank 0 (K₀=K). The process thus uses an initial set initial of N1 keys Kj (K₀, K₁, K₂ . . . K_{N1-1}) wherein only key K₀ is authentic.

According to the invention, the process CP3 comprises the following steps:
round RD₁ is executed N1 times by means of N1 sub-keys SK_{1,j} (SK_{1,0}, SK_{1,1}, SK_{1,2} . . . SK_{N1-1}) generated from initial set of N1 keys Kj (K₀, K₁, K₂ . . . K_{N1-1}),
round RD₂ is executed N2 times, N2≦N1, by means of N2 sub-keys SK_{2,j} (SK_{2,0}, SK_{2,1}, SK_{2,2} . . . SK_{2,N2-1}) generated from a sub-set of N2 keys Kⱼ (K₀, K₁, K₂ . . . K_{N2-1}) which is included in the initial set of N1 keys,
Etc.,
round RDᵢ is executed Nᵢ times, Nᵢ≦Nᵢ₋₁ and Nᵢ₋₁ being the number of executions of the preceding round, by means of Nᵢ sub-keys SK_{i,j} (SK_{i,0}, SK_{i,1}, SK_{i,2} . . . SK_{i,Ni-1}) generated from a set of Nᵢ keys Kⱼ (K₀, K₁, K₂ . . . K_{Ni-1}) included in the initial set of N1 keys,
Etc.,
round RD_{Nr-1} is executed N_{Nr-1} times, N_{Nr-1}≧N_{Nr-2} and N_{Nr-2} being the number of executions of the preceding round, by means of N_{Nr-1} sub-keys SK_{Nr-1,j} (SK_{Nr-1,0}, SK_{Nr-1,1}, SK_{Nr-1,2} . . . SK(Nr−1,N_{Nr-1}−1) generated from a set of N_{Nr-1} keys Kⱼ (K₀, K₁, K₂ . . . K(N_{Nr-1}−1)) included in the initial set of N1 keys, and
the last round RD_{Nr} is executed N_{Nr} times, N_{Nr}≧N_{Nr-1}, by means of N_{Nr} sub-keys SK_{Nr,j} (SK_{Nr,0}, SK_{Nr,1}, SK_{Nr,2} . . . SK(Nr,N_{Nr}−1)) generated from a set of N_{Nr} keys Kⱼ (K₀, K₁, K₂ . . . K(N_{Nr-1})) included in the initial set of N1 keys.

The relation between the number of executions of each round RDᵢ is controlled by a first countermeasure rule, which may be formalized in the following manner, reference being made to rounds RD₁, RD₂, RD₃, RD₄ . . . RDᵢ . . . RD_{Nr-3}, RD_{Nr-2}, RD_{Nr-1}, RD_{Nr} of which certain are not shown in FIG. 4:

### Rule 1:

N1≧N2≧N3≧N4 . . . ≧Nᵢ with at least N1>N2 or N2>N3,
N_{Nr}≧N_{Nr-1}≧N_{Nr-2}N_{Nr-3} . . . ≧Nᵢ with at least N_{Nr}>N_{Nr-1} or N_{Nr-1}>N_{Nr-2}.

### Examples:

N1>N2≧N3≧N4 . . . ≧Nᵢ and N_{Nr}>N_{Nr-1}≧N_{Nr-2}≧N_{Nr-3} . . . ≧Nᵢ
N1=N2>N3≧N4 . . . ≧Nᵢ and N_{Nr}=N_{Nr-1}>N_{Nr-2•}≧•N_{Nr-3} . . . ≧Nᵢ
N1>N2=N3≧N4 . . . ≧Nᵢ and N_{Nr}>N_{Nr-1}=N_{Nr-2•}≧N_{Nr-3} . . . ≧Nᵢ
N1>N2>N3=N4 . . . =Nᵢ and N_{Nr}>N_{Nr-1}>N_{Nr-2}=N_{Nr-3} . . . =Nᵢ

In certain embodiments, the distribution of the number of executions may be different for the first and last rounds, for example:
N1>N2≧N3≧N4 . . . ≧Nᵢ and N_{Nr}=N_{Nr-1}>N_{Nr-2}≧N_{Nr-3} . . . ≧Nᵢ

According to an optional second countermeasure rule defining a sort of process “symmetry” with respect to the central rounds, the number of executions of the last round is equal to the number of executions of the first round, the number of executions of the second round is equal to the number of executions of the next to last round, and so forth until a certain “distance” from the first and last rounds. This rule may be formalized in the following manner.

### Second Rule:

If i<ls, then Nᵢ=N_{Nr-i+1},

ls being a threshold defining the “distance” of a round relative to the first and last rounds.

### Example:

N1=N_{Nr}
N2=N_{Nr-1}
N3=N_{Nr-2}
Etc. until the threshold ls.

The threshold ls may be chosen to be greater than the number of rounds to obtain a total symmetry of the process as far as the number of round executions relative to the central rounds is concerned.

According to an optional third countermeasure rule “rule 3”, the execution of certain intermediary rounds is not repeated, in particular for the central rounds. For the implementation of this rule, a number of rounds to protect “NRtoP” is defined, relative to the first and to the last round. The number of rounds to protect represents the number of rounds that need to be executed several times. The rounds that do not belong to the group of rounds to protect are considered as “central” rounds and are only executed once, with the true key K₀ (i.e. the authentic key). Rule 3 may be formalized as follows.

### Rule 3:

NRtoP=number of rounds to protect
If i>NRtoP and i≦Nr-NRtoP, then Nᵢ=1

Numerical example in the case of an encryption process comprising 16 rounds RD₁ to RD₁₆ (Nr=16)
NRtoP=3 (i.e. 3 rounds to protect),
If i>3 and i≦16-3 (i.e. i≦13), then N₁=1

In this case, the rounds RD₄, RD₅, RD₆, RD₇, RD₅, RD₉, RD₁₀, RD₁₁, RD₁₂, RD₁₃ are only executed once.

In certain embodiments, the number of executions Nᵢ of each round RDᵢ (for i from 1 to Nr) may be determined by means of a relation which is a function of the rank i of the considered round. Rule 4 below is an example of a relation 1/(2ⁿ), n being a variable function of i. Rule 4 includes rule 2 as far as the rounds to protect are considered and includes rule 3 as far as the rounds not to protect are considered.

### Rule 4:

NRtoP=number of rounds to protect
For i from 1 to Nr do:
If i≦NRtoP then n=i−1 and Nᵢ=N1/(2ⁿ)
Otherwise:
If i>Nr-NRtoP then n=Nr−i and Nᵢ=N1/(2ⁿ)
Otherwise:
Nᵢ=1 (Rule 3)

Rule 4 may be formulated more simply by means of the minimum operator “min”:
NRtoP=number of rounds to protect:
For i from 1 to Nr do:
If i NRtoP or i>Nr-NRtoP, do:
n=min(i−1, Nr−i)
Nᵢ=N1/(2ⁿ)
Otherwise:
Nᵢ=1 (Rule 3)

Reference is now made to Annex 1, an integral part of the description. Table 1 of Annex 1 describes a numerical application example of rule 4, with Nr=16 and NRtoP=3. If N1=8, it follows that: N2=4, N3=2, N4 to N13=1, N14=2, N15=4 and N16=8. If N1=16, it follows that N2=8, N3=4, N4 to N13=1, N14=4, N15=8 and N16=16.

Table 2 of Annex 1 describes embodiments CP31, CP32, CP33, CP34, CP35, CP36 of the encryption process CP3 implementing rules 1 and 2. These embodiments relate to an encryption process comprising 16 rounds (Nr=16), for example the DES process. The maximum execution number N1 is equal to 8 for the embodiments CP31 to CP34, CP36, and is equal to 12 for the embodiment CP35. The embodiment designated by the reference CP30 does not implement rule 1 and is not considered as comprised in the invention because it does not provide any advantages as far as calculation time is considered. It represents the number of round executions that a conventional countermeasure would need comprising 8 successive executions of the encryption process, which would require 8*16, that is 128 round executions.

In table 2, column T provides the total number of round executions, column CT gives the calculation time for each embodiment CP31 to CP36 as a percentage of the calculation time of embodiment CP30, that is, relative calculation time. This relative calculation time CT is equal to the total number of execution of rounds divided by the total number of executions of rounds in the case embodiment CP30, that is (T/128)*100. Column G or “Time gained” is the 100 complement of the relative calculation time CT, that is, G=100−CT.

Embodiments CP34, CP35, CP36 also implement rule 3 (no multiple execution of certain central rounds) and embodiment CP36 also implements rule 4 with NRtoP=3 and Nr=8. These examples show that the time gain depends on both the distribution of the number of intermediary rounds executions and on the maximum number of executions of the first and of the last round. For example, embodiment CP35 in which N1=12 offers a time gain of 55% greater than the time gain of 44% offered by the embodiment CP33 in which N1=8, because rounds 6 to 11 are only executed once.

In an implementation variation, rule 3 is modified such that the number of executions of “central” rounds is fixed but greater than 1, which corresponds for example to embodiments CP31 and CP32 where the central rounds are executed twice.

As another example, table 3 on page 1 of Annex 1 describes the total T number of rounds executions as a function of the number of rounds Nr as well as the relative calculation time CT (relative to embodiment CP30) when rule 4 is used to determine the number of executions, and when the number of rounds to protect NRtoP is equal to 4.

Still to illustrate the advantages of a countermeasure process according to the invention, FIG. 5 shows the curve CR1 of the total T number of rounds executions as a function of the number of rounds Nr when rule 4 is used, and when the number of rounds to protect NRtoP is equal to 4. The curve has the form of a straight line and its slope is determined by the parameter NRtoP. For comparison, curve CR2 of the total T number of rounds executions as a function of the number de rounds Nr in the case of a conventional implementation.

Reference is now made to Annex 2, an integral part of the description, which describes, in the form of executable algorithms, implementation examples of encryption methods protected according to the invention. The sub-round operations that each encryption process executes are set forth in tables 4 and 5 of Annex 1.

### Application to DES Encryption

The encryption process is executed by means of a “Protected DES” algorithm PDES1 and of a “Protected Round DES” algorithm PRDES1 or round algorithm. The round algorithm PRDES1 is a sub-function of the algorithm PDES1, and is called by algorithm PDES1 at each new iteration of the variable i, which forms a round number.

In the PDES1 algorithm, the permutation operations IP, inverse permutation operations IPinverse, and dividing the message in two 32-bit blocks bits executed at steps 3, 4, 8 are known to the skilled person and will not described in detail here. A first pair of values (L₀, R₀) is calculated at step 4 from the message M after its permutation at step 3. The values are for the execution of the first round by the algorithm PRDES1. Then, steps 5, 6, 6.1, 6.2, 7, and 7.1 implement rule 4 described above, and thus determine the number of executions of a round as a function of its rank and of the parameter NRtoP. Steps 6.3 and 7.2 are calls to the round function executed by the algorithm PRDES1.

In the algorithm PRDES1, the cryptographic tables C, D, E, F (in practice, binary chains), the random permutation operations, the generation of sub-keys, the concatenation operator “I”, as well as the sub-round operations described in table 4 of Annex 1 (expansive permutation, substitution, XOR, permutation) are also known to the skilled person. The sub-rounds 1 to 4 are included in the loop 13 and are thus each repeated as many times as the number of iterations of the variable j. Variable j has N₁ values determined by the algorithm PDES1. When algorithm PRDES1 has been called by the algorithm PDES1 with N₁=1 (steps 7.1 and 7.2), the loop 13 only comprises one value of j. The sub-rounds are therefore only executed once with the sub-key corresponding to the true key K₀.

The random permutation executed at step 12 allows the selection of the Nᵢ first sub-keys of the set of sub-keys SK_{i,0} to SK_{i,N1-1} to form a set of sub-keys SK_{i,p0} to SK_{i,pj} for j from 0 to Nᵢ−1, pj being an element of rank j in the random permutation P. When Nᵢ=N1, all the sub-keys are used. When Nᵢ=1, only the true sub-key SK_{i,0} is used (i.e. the sub-key corresponding to the true key K₀). This random permutation also allows the sub-keys to be classed in a random order for the execution of the loop 13. Thus, the first sub-key used for the first iteration (j=0) of the loop 13 is not necessarily the sub-key SK_{i,0}. At each new execution of algorithm PRDES1, the usage order of the sub-keys is random.

Once the round has been repeated Nᵢ times, algorithm PRDES1 sends back the pair of values (Lᵢ, Rᵢ) which are a function of the pair of values initially received on input (Lᵢ₋₁, Rᵢ₋₁), the number i of the round (which determines the values of the sub-keys), and the execution number Nᵢ of the round.

In the algorithm PRDES1, the generation of sub-keys, from keys K₀ to K_{Ni-1} or from sub-keys of a preceding round, required for the execution of each round may be done in several ways:
for each key K₀ to K_{N1-1}, the sub-keys required for the round executions are generated ahead of time and are stored in a protected memory. This method requires a certain amount of memory space, which may not be compatible with certain applications,
during each execution of a round, the sub-keys required for the round are generated “on the fly” as a function of keys or sub-keys of the round immediately preceding, associated with the key being used. All the sub-keys are generated for each round, including those for which the algorithm PRDES1 does not have need when the round is executed a number of times less than the number of keys, so that for the execution of the following round, the algorithm PRDES1 has all the sub-keys previously required for the generation of sub-keys for the considered round.

The second solution presented has been retained here and appears at step 11. In step 11, N1 sub-keys are generated for each round from N1 keys or N1 sub-keys generated during the execution of the preceding round. The number of sub-keys generated is independent of the number of executions of the considered round and is thus the number of sub-keys actually required by the algorithm PRDES1 for the execution of the round.

It will be noted that in the case of the DES process, known methods of generating fake keys allow the generation of sub-keys for all the fake keys from sub-keys of the authentic key. Thus, instead of generating the sub-keys of a fake key from preceding sub-keys of the same false key, the sub-keys of the false key may also be generated from sub-keys of the authentic key. In the case of the AES process, the sub-keys of a false key must however be generated from precedent sub-keys of the false key.

It will clearly appear to the skilled person that various other algorithms implementing the principles of the invention may be provided to execute the DES process, since algorithms PDES1 and PRDES1 are only examples.

### Application to TDES (Triple DES) Encryption

The encryption process according to the invention is here executed by means of a PTDES (“Protected TDES”) algorithm appearing in Annex 2 and algorithms PDES1 and PRDES1 described above.

The TDES encryption conventionally comprises a first step of DES encryption of the message with a first key K, i.e. DES(M,K). A step of DES⁻¹ inverted encryption of the result of the first step with a second key K′ is then performed, i.e. DES⁻¹(DES(M,K),K′). Finally, a DES encryption step is performed of the result of the second step with the first key K, as follows:
DES(DES⁻¹(DES(M,K),K′),K)

In the PTDES algorithm, the first DES encryption step (step 20) is executed by calling algorithm PDES1, which then calls algorithm PRDES1, after having defined the maximum number N1 of rounds executions and the number of rounds to protect NRtoP.

The second DES⁻¹ encryption step may be executed by means of a conventional DES⁻¹ process unprotected from side channel attacks (step 21a), or by means of the algorithm PDES1⁻¹, the inverse PDES1 algorithm described in Annex 2 (step 21b). Algorithm PDES1⁻¹ is not described in Annex 2 but may be derived from the PDES1 algorithm by replacing the operation IP of step 3 by the operation IPinverse, and by replacing the operation IPinverse of step 8 by the operation IP, and by inverting the usage order of the sub-keys (that is, from SK₁₆ to SK₁). As step 21b provides that N1=1 and NRtoP=0, algorithm PDES1⁻¹ is unprotected and is equivalent to a conventional DES⁻¹ process.

Finally, the last DES encryption step (step 22) is protected and is executed by calling algorithm PDES1 which then calls algorithm PRDES1, by defining the maximum number N1 of round executions and the number of rounds to protect NRtoP.

### Application to the AES 128 Encryption

The example described in Annex 2 relates to AES 128 of 10 rounds but the invention may also be applied to AES 192 of 12 rounds and to AES 256 of 14 rounds.

The process is executed by means of an algorithm PAES1 (“Protected AES”) and an algorithm PRAES1 (“Protected Round AES”) or round algorithm. Algorithm PRAES1 is a sub-function of algorithm PAES1 which is called by this latter at each new iteration of round number i.

In algorithm PAES1, steps 33, 34, 34.1, 34.2, 35, 35.1 implement rule 4 described above, and thus determine the number of executions of a round as a function of its rank and of the parameter NRtoP. Steps 34.3 and 35.2 are calls to the round function executed by algorithm PRAES1.

Algorithm PRAES1 executes the sub-round operations described in table 5 in Annex 1 (AddRoundKey, SubByte, ShiftRow, and MixColumn), in and of themselves known to the skilled person. The structure of rounds executed by algorithm PRAES1 is shown in FIG. 6 in the form of a flowchart AES2. Flowchart AES2 differs from the flowchart AES1 of FIG. 2 in that the sub-rounds have been reorganized by commodity in a manner to get rid of the initial operation IO comprising the operation AddRoundKey. The operation AddRoundKey is integrated in the first round RD1 and at the beginning of each following round, causing a sub-key SK_{i-1,j} of rank i−1,j to intervene in each following round of rank i,j. Operation AddRoundKey is followed by operations SubByte, ShiftRow, and MixColumn in rounds RD1 to RD9. The last round RD10 comprises two executions of the operation AddRoundKey, causing the is two last sub-keys SK₉ and SK₁₀ of the current key of rank j to intervene. Between these two operations, the operations SubByte and ShiftRow are executed. The skilled person may of course provide any other structure of rounds respecting the AES specifications.

In algorithm PRAES1, the sub-rounds AddRoundKey, SubByte, and ShiftRow are included in the iterative loop 43 and are thus each repeated as many times as the number of iterations of the variable j. The operation MixColumn is equally included in la loop 43 for all values of round number i different than 10. Loop 43.6 is executed when i is equal to 10 and is included in loop 43 only for round 10. It comprises a new generation of sub-keys (step 43.6.1) and the second execution of the operation AddRoundKey (step 43.6.2).

As previously, the random permutation operation executed at step 42 allows the selection of the Nᵢ first sub-keys of the set of sub-keys SK_{i,0} to SK_{i,N1-1} to form a set of sub-keys SK_{i,p0} to SK_{i,pj} for j from 0 to Nᵢ−1. When Nᵢ=N1, all the sub-keys are used. When Nᵢ=1, only the true sub-key SK_{i,0} is used (i.e. the sub-key corresponding to the true key K₀). This random permutation operation also allows the sub-keys to be classed in a random order for the execution of the loop 43.

It will be understood by the skilled person that various other algorithms implementing the principles of the invention may also be provided to execute the AES process.

### Embodiments of the Invention Based on the Notion of Modularity

In embodiments of the invention based on the notion of modularity, the multiple execution of a round comprises:
the multiple execution of one or more sub-rounds of the considered round,
a single execution of one or more other sub-rounds of the considered round.

The previously described rules, relating to the determination of the number of executions of each round, are conserved. However, the way in which each round is executed several times is modified. In other words, each sub-round, and more particularly, each encryption operation that comprises each sub-round, is considered as a “module” having its own number of executions.

As an example, FIG. 7 shows an encryption process CP4 according to the invention, for example the DES process. Process CP4 is based on the same multiple rounds execution model as the process CP3, and differs from it by the fact that only the sub-round SRD3 of each round RD₁, RD₂ . . . RD_{Nr} is executed several times. The process CP4 comprises therefore the following steps:
sub-round SRD3 of round RD₁ is executed N1 times whereas the other sub-rounds are only executed once with key Kₒ,
sub-round SRD3 of round RD₂ is executed N2 times, with N2<N1, whereas the other sub-rounds are only executed once with key K₀,
etc.,
sub-round SRD3 of round RDᵢ is executed Nᵢ times, with Nᵢ≦Nᵢ₋₁ (Nᵢ₋₁ being the number of executions of the preceding round) whereas the other sub-rounds are only executed once with key K₀,
Etc.,
sub-round SRD3 of the next-to-last round RD_{Nr-1} is executed N_{Nr-1} times, whereas the other sub-rounds are only executed once with key K₀, and
sub-round SRD3 of the last round RD_{Nr} is executed N_{Nr} times, with N_{Nr}≧N_{Nr-1}, whereas the other sub-rounds are only executed once with key K₀.

This embodiment allows the execution time of the encryption process to be further accelerated by limiting, within rounds executed several times, the number of sub-rounds that are themselves executed several times. It may comprise the provision of several independent hardware functions or “material modules”, each executing a sub-round or a sub-round operation, instead of and in place of a single hardware round function comprising all the sub-rounds.

This modularity allows, on one hand, to multiply the sub-function calls during a round and to vary the number of these calls as a function of the round currently performed, but also to define sub-functions useable for several encryption methods. In other words, instead of providing a coprocessor dedicated to a determined encryption process, embodiments of the invention provide several hardware accelerators useable by several encryption processes, each one implementing a sub-round operation. Thus, in the example shown in FIG. 7, each sub-round SRD1 to SRD4 may be executed by means of a dedicated hardware accelerator.

By precaution, a countermeasure may be provided to protect the sub-rounds that are only executed once against side channel attacks. This countermeasure may in particular be a masking countermeasure. Thus, in FIG. 7, sub-rounds SRD1, SRD2, SRD4 of round RD₁ are protected by a random mask U1, sub-rounds SRD1, SRD2, SRD4 of round RD₂ are protected by a random mask U2, etc., and sub-rounds SRD1, SRD2, SRD4 of round RD_{Nr} are protected by a random mask U_{Nr}.

The choice of a sub-round protection mode, by masking or by multiple executions, may be made as a function of the nature of the operation that comprises the sub-round. To this end, the sub-rounds that comprise a linear operation and those that comprise a non-linear operation in the mathematical sense of the term are distinguished. In particular, an operation is non linear when its execution is based on a determined tabled stored in memory.

Masking example of a linear operation:
M is a message,
K is a secret key.
Normal operation: C=M XOR K (combination of the message with the key)
Protected operation (masked):
   Randomly select, at each iteration, a mask U having the same number of bits as the message M,
   Calculate C=M XOR U (masking of message M with the mask U),
   Calculate C=C XOR K (combination of the masked message with the key),
   Calculate C=C XOR U (demasking)

The protected operation produces the same result as the unprotected operation.

Masking example with a non-linear operation “S”:
M is a message,
K is a secret key,
S is a table,
X=K XOR M.
Normal operation:
   For i=0 to 7 do:
      S(Xᵢ)=Yᵢ

A DPA or CPA attack knowing M may allow the key K to be found by predicting the value S(Xᵢ).
Protected operation (masked):
   Randomly select a mask U,
   Recalculate the table S to obtain a new table S′:
      For I=0 to 256 do:
      S′(i XOR U)=S(i) XOR U
   For i=0 to 7 do:
      X′ᵢ=Xᵢ XOR U
      Y′ᵢ=S′(X′ᵢ)
      Yᵢ=Y′ₗ XOR U

As previously, the protected operation produces the same results as the unprotected operation.

Because the masking of a table with a plurality of mask requires a large memory space, a masking countermeasure has the inconvenience of occupying a large memory space in the case of a non-linear operation. Thus, to reduce the memory space used, the same mask, for example a mask of 8 bits, is generally used for all sub-rounds of the round or for all the values of the table. The masking is therefore called “single order” as opposed to a higher order masking, which uses a plurality of random masks.

Nevertheless, single order masking introduces a weakness against attacks by higher-order DPA. However, if the non-linear masked single order operation is executed several times with false keys, the “true” operation will be lost in a sea of false operations and the result of an attack will be comparable to noise. Certain embodiments of the invention thus provide multiple executions of non-linear masked single order operations. In this case, and advantageously, it is not necessary to provide a higher order mask because it is almost impossible, with the current body of knowledge, to carry out a higher order attack on an operation executed several times with a single order masking.

In summary, in certain embodiments, the linear operations are protected by multiple executions, or by a higher order masking, or else by a single order masking and multiple executions, whereas the non-linear operations are preferably protected by a single order masking and multiple executions.

Thus, in the process CP4 shown in FIG. 7, numerous combinations of countermeasures may be provided. Supposing that the sub-rounds SRD1, SRD2, and SRD4 are linear and that sub-round RD3 is non-linear, the following countermeasures may be provided:
Countermeasure 1:
   sub-rounds SRD1, SRD2, and SRD4 are only executed once per round and are protected by a single or higher order masking,
   sub-round SRD3 is executed several times per round, without masking.
Countermeasure 2:
   sub-rounds SRD1, SRD2, and SRD4 are only executed once per round and are protected by a single or higher order masking,
   sub-round SRD3 is executed several times per round, with a single order masking.
Countermeasure 3:
   sub-rounds SRD1, SRD2, and SRD4 are executed several times per round, without masking,
   sub-round SRD3 is executed several times per round, with a single order masking.
Countermeasure 4:
   sub-rounds SRD1, SRD2, and SRD4 are executed several times per round, with a single or higher order masking,
   sub-round SRD3 is executed several times per round, with a single order masking.

Countermeasure 4 offers a higher level of security than those offered by countermeasures 2 and 3, which offer higher levels of security that that offered by countermeasure 1. Nevertheless, searching for a better ratio between execution time and protection against attacks, countermeasures 2 and 3 already offer an excellent level of protection. Furthermore, one can add random executions within these operations.

Reference is now made to Annex 3, an integral part of the description, which describes, in the form of executable algorithms, realization examples of encryption methods protected according to the invention, implementing the notion of modularity.

### Application to DES Encryption

The process is executed by means of an algorithm PDES2 and of a round algorithm PRDES2 appearing in Annex 3. Algorithm PDES2 differs from algorithm PDES1 in that it comprises initial steps 54, 55 of generating a first mask U₀ and of generating left and right parts U_{0,L} and U_{0,R} of the mask, followed by a step 56 of masking left and right parts L₀, R₀ of the message M. Further, step 6.3 to call algorithm PRDES1 is replaced by a step 58.3 to call algorithm PRDES2, and step 7.2 to call algorithm PRDES1 is replaced by a step 59.2 to call algorithm PRDES2. Finally, when all the rounds have been executed by means of algorithm PRDES2, a step 60 of demasking the result is provided. The operation IPinverse then allows the encrypted message C to be obtained.

Round algorithm PRDES2 uses the same encryption operations and comprises the same sub-rounds as algorithm PRDES1, but implements the notion of modularity. It receives as Input Data, as previously:
keys K₀ to K_{N1-1} or sub-keys of the preceding round,
the pair of values (Lᵢ₋₁, Rᵢ₋₁) supplied by the preceding execution of round algorithm PRDES2 or by step 56 of algorithm PDES2 as far as the pair of initial values (Lᵢ₋₁, Rᵢ₋₁) is concerned,
the round number i (for the calculation of sub-keys), and
the number of executions Nᵢ of the considered round.

Round algorithm PRDES2 also receives, as input data, a random mask Uᵢ₋₁. The random mask is the mask U₀ generated by algorithm PDES2 at step 54, or a mask Uᵢ₋₁ provided by the preceding execution of algorithm PRDES2, calculated at step 78.

Sub-round 1 comprises the linear Expansive Permutation operation and is only executed once at step 75 with a higher order masking. Sub-round 2, arranged in the iterative loop 76, comprises the linear XOR operation and is executed several times at step 76.1 with a higher order masking. Sub-round 3 comprises the non linear Substitution operation, also present in loop 76, and is executed several times at step 76.3 in unmasked form, as it is preceded by a demasking step 76.2. The result of this operation is then masked again at step 76.4. Finally, sub-round 4, which comprises the linear XOR operation, is only executed once with a higher order masking at step 77. A mask Uᵢ of rank i for the next round is then calculated at step 78 and an update of mask Uᵢ₋₁ is performed at step 79. The algorithm then returns the result Lᵢ, Rᵢ and the mask Uᵢ.

It will be understood by the skilled person that various other algorithms implementing the principles of the invention may be provided to execute the DES process.

### Application to AES Encryption

The process is executed by means of an algorithm PAES2 and of a round algorithm PRAES2 appearing in Annex 3. Algorithm PAES2 differs from algorithm PAES1 in that it comprises a step 92 of generating an initial random mask Uₒ and a step 93 of masking message M. Step 34.3 to call algorithm PRAES1 is replaced by a step 95.3 to call algorithm PRAES2 and the step 35.2 to call algorithm PRAES1 is replaced by a step 96.2 to call algorithm PRAES2. When all the rounds have been executed, the final result C is unmasked at step 97 to obtain the encrypted message C.

Round algorithm PRAES2 uses the same encryption operations and comprises the same sub-rounds as algorithm PRAES1, but implement the notion of modularity.

Thus, in algorithm PRAES2, sub-round 1 comprising the linear AddRoundKey operation (step 104.1) is included in the iterative loop 104 and is executed several times with a higher order masking. Sub-round 2 comprising the non linear SubByte operation (step 104.3) is executed several times in the unmasked form, after a demasking step 104.2. The result of this sub-round is then masked again at step 104.4. Sub-round 3 comprising the linear ShiftRow operation is not within the loop 104 and is only executed once at step 105, with a higher order masking. Sub-round 4, comprising the linear MixColumn operation (step 106.1), of rounds 1 to 9 is also not within the loop 104 and is only executed once, with a higher order masking. Sub-round 4, comprising the linear AddRoundKey operation, of round 10 (step 107.3.1) is executed several times with a higher order masking within the loop 107, after a new generation of sub-keys (step 107.1) and step of updating the mask (step 107.2).

It will clearly appear to the skilled person that various other algorithms implementing the principles of the invention may be provided to execute the AES process.

The invention applies in a general manner to all types of symmetric block encryption processes comprising rounds. Embodiments of the invention based on the modularity notion may be applied to all processes of this type in which each round comprises a plurality of sub-rounds.

Embodiments of an encryption process according to the invention may implement only the second aspect of the invention relating to the modularity of sub-rounds, without the first aspect of the invention providing a variable number of executions of rounds as functions of their rank. Such embodiments may therefore comprise an identical number of executions of each round, but a different number of executions of each sub-round within a round executed several times, certain sub-rounds being executed only once, preferably in masked form, and other sub-rounds being executed several times, in masked or unmasked form.

A microcircuit configured to execute a process according to the invention is itself susceptible to various embodiments. For example, the algorithms appearing in Annex 2 and Annex 3 may be executed by the CPU of the principal processor or partly by the CPU and by a coprocessor. In particular, the algorithms PDES1, PDES2, PTDES, PAES1, PAES2 may be executed by the CPU and the rounds algorithms PRDES1, PRDES2, PRAES1, PRAES2 may be executed by a coprocessor or by hardware accelerators. Algorithms PRDES2 and PRAES2 based on the modularity principle may advantageously be executed by a modular coprocessor or several hardware accelerators in parallel forming the equivalent of a modular coprocessor, allowing the CPU to call each sub-round function independently of the others, with or without masking, for a single or multiple execution of these functions.

FIG. 8 schematically shows an example of a secure device SDV comprising a microcircuit MCT according to the invention, mounted on a support CD, for example a plastic card. Microcircuit MCT comprises a processor PROC including a central processing unit (CPU), a coprocessor CPROC coupled to the processor, a communication interface ICCT coupled to the processor, a memory MEM1 coupled to the principal processor, a random or pseudo-random generator RGEN coupled to the principal processor and/or to the coprocessor. Elements PROC, CPROC, ICCT MEM1, RGEN may be integrated on a same semiconductor chip or, for certain elements, be integrated in different semiconductor chips that are interconnected by a printed circuit or other interconnection support.

Circuit ICCT may be of the contact type (wired communication port), of the contactless type (NFC, Wifi, Bluetooth®, etc. interface), or of both types. In certain applications, in particular in the framework of an authentication process of the device SDV, the message to encrypt M is received by the intermediary of the communication interface circuit ICCT and the encrypted message C is communicated to the exterior also by the intermediary of this interface circuit.

Memory MEM1 may comprise a volatile memory zone and an electrically programmable non volatile memory zone. The non volatile memory may comprise a secure zone comprising a secret key K. The random or pseudo-random generator RGEN is used by the processor or the coprocessor to generate the false keys and/or random masks of the type described above. The coprocessor may be dedicated to the execution of rounds of a determined encryption, or be of the modular type as described above, for the execution of hardware functions allowing the processor to execute each sub-round independently of the others.

### ANNEX 1 (Integral Part of the Description)

TABLE 1

| i | i ≦ 3 | i > 13 | min(i-1,16-i) | Nᵢ |
|---|---|---|---|---|
| 1 | yes | no | min(0,16) = 0 | N1 = N1 |
| 2 | yes | no | min(1,15) = 1 | N2 = N1/2 |
| 3 | yes | no | min(2,14) = 2 | N3 = N1/4 |
| 4 | no | no | Not applicable | 1 |
| 5 | no | no | Not applicable | 1 |
| 6 | no | no | Not applicable | 1 |
| 7 | no | no | Not applicable | 1 |
| 8 | no | no | Not applicable | 1 |
| 9 | no | no | Not applicable | 1 |
| 10 | no | no | Not applicable | 1 |
| 11 | no | no | Not applicable | 1 |
| 12 | no | no | Not applicable | 1 |
| 13 | no | no | Not applicable | 1 |
| 14 | no | yes | min(13,2) = 2 | N14 = N1/4 |
| 15 | no | yes | min(14,1) = 1 | N15 = N1/2 |
| 16 | no | yes | min(15,0) = 0 | N16 = N1 |

TABLE 2

| | i | | | | | | | | | | | | | | | | | | |
|---|---|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | | | |
| Ni | N1 | N2 | N3 | N4 | N5 | N6 | N7 | N8 | N9 | N10 | N11 | N12 | N13 | N14 | N15 | N16 | T | CT | G |
| CP30 | 8 | 8 | 8 | 8 | 8 | 8 | 8 | 8 | 8 | 8 | 8 | 8 | 8 | 8 | 8 | 8 | 128 | 100% | 0% |
| CP31 | 8 | 4 | 4 | 2 | 2 | 2 | 2 | 2 | 2 | 2 | 2 | 2 | 2 | 4 | 4 | 8 | 52 | 41% | 59% |
| CP32 | 8 | 2 | 2 | 2 | 2 | 2 | 2 | 2 | 2 | 2 | 2 | 2 | 2 | 2 | 2 | 8 | 44 | 34% | 66% |
| CP33 | 8 | 4 | 4 | 4 | 4 | 4 | 4 | 4 | 4 | 4 | 4 | 4 | 4 | 4 | 4 | 8 | 72 | 56% | 44% |
| CP34 | 8 | 4 | 4 | 2 | 2 | 1 | 1 | 1 | 1 | 1 | 1 | 2 | 2 | 4 | 4 | 8 | 46 | 36% | 64% |
| CP35 | 12 | 6 | 4 | 2 | 2 | 1 | 1 | 1 | 1 | 1 | 1 | 2 | 2 | 4 | 6 | 12 | 58 | 45% | 55% |
| CP36 | 8 | 4 | 2 | 1 | 1 | 1 | 1 | 1 | 1 | 1 | 1 | 1 | 1 | 2 | 4 | 8 | 38 | 30% | 70% |

TABLE 3

| | |
|---|---|
| CP30 | Rule 4 with NRtoP = 4 |

| N1 | T | T | CT |
|---|---|---|---|
| 4 | 64 | | |
| 8 | 128 | 38 | 29.6% |
| 16 | 256 | 68 | 26.5% |
| 32 | 512 | 128 | 25% |
| 64 | 1024 | 248 | 24.2% |

TABLE 4
DES Process (Cf. FIPS PUB 46-3 of the NIST)

| Sub-round | Abbreviation(*) | Designation |
|---|---|---|
| Sub-round 1 | E | ExpansivePermutation |
| Sub-round 2 | XOR | XOR (Exclusive OR) |
| Sub-round 3 | S | Substitution |
| Sub-round 4 | P | Permutation |

(*)Abbreviation forming the official designation of sub-rounds in the FIPS (Federal Information Processing Standard) PUB 46-3 standard of the NIST (National Institute of Standards and Technology).

TABLE 5
AES Process (Cf. FIPS PUB 197 of the NIST)

| Sub-round | Abbreviation | Designation (**) |
|---|---|---|
| Sub-round 1 | — | AddRoundKey |
| Sub-round 2 | — | SubBytes |
| Sub-round 3 | — | ShiftRows |
| Sub-round 4 | — | MixColumns |

(**) Official designation used in the FIPS PUB 197 standard of the NIST.

### ANNEX 2 (Integral Part of the Description)

Algorithm PDES1 (Protected DES)

Input Data :
- K Key
- M message to encrypt
- N1 maximum number of executions of a round
- NRtoP number of rounds to protect
Output Data :
- Encrypted message C=DES(M, K)=PDES1(M, K, N1, NRtoP)
Start :

(1) K₀=K
(2) Generate N1-1 false keys (K₁, K₂... K_{N1-1})
(3) M=IP(M)
(4) Split M into two blocks, L₀ and R₀, of 32 bits

L₀=32 most significant bits of M
R₀=32 least significant bits of M

(5) For i from 1 to 16 do :

(6) If (i ≦ NRtoP) or (i > 16-NRtoP) then

(6.1) n=min(i-1, 16-i)
(6.2) Nᵢ= N1/(2ⁿ)
(6.3) (Lᵢ, Rᵢ)=PRDES1(Lᵢ₋₁, Rᵢ₋₁, i, Nᵢ) [Protected Round]

(7) Otherwise

(7.1) Nᵢ=1
(7.2) (Lᵢ, Rᵢ)=PRDES1(Lᵢ₋₁, Rᵢ₋₁, i, Nᵢ) [Unprotected Round]

(8) C=IPinverse (R₁₆ | L₁₆)
(9) Return C

End

Algorithm PRDES1 (Protected Round DES)

Notation :
- i : rank of the processed round
- Nᵢ : number of executions of a round of rank i
- N1 (Nᵢ with i=1) : maximum number of executions of a round (first and
last)
Input Data :
- keys (K₀, K₁, K₂... K_{N1-1}) or sub-keys of a preceding round
- pair (Lᵢ₋₁, Rᵢ₋₁)
- i round number
- Nᵢ number of executions
Output Data :
- (Lᵢ, Rᵢ)=PRDES1(Lᵢ₋₁, Rᵢ₋₁, i, Nᵢ)
Start :

(10) For C, D, E, F, four tables of 4 bytes
(11) Generate N1 sub-keys (SK_{i,0}, SK_{i,1}, SK_{i,2}... SK_{i,N1-1}) for round i
from keys K₀, K₁, K₂... K_{N1-1} or from sub-keys of a preceding round
(12) Generate a random permutation P={p₀... p_{Ni-1}} in the interval
j=[0, Nᵢ-1]
(13) For j from 0 to (Nᵢ-1) do :

(13.1) T_{R}=Rᵢ₋₁, T_{L}=Lᵢ₋₁
(13.2) W =Rᵢ₋₁
(13.3) T_{R}= ExpansivePermutation(T_{R}) [Sub-round 1]
(13.4) T_{R}=T_{R} XOR SK_{i,pj} [Sub-round 2]
(13.5) T_{R}=Substitution(T_{R}) [Sub-round 3]
(13.6) T_{R}=Permutation(T_{R}) XOR T_{L} [Sub-round 4]
(13.7) If pj=0 then

```
  C=W
  D =T_{R}
```

(13.8) If pj ≠ 0 then

```
  E=W
  F=T_{R}
```

(14) Li=C, Ri=D
(15) Return (Li,Ri)

End

Algorithm PTDES (Protected Triple DES)

Input Data :
- K and K′ : cryptographic keys
- M : message to encrypt
- N1 (Nᵢ with i=1) : maximum number of executions of a round (first and
last)
- NRtoP : number of rounds to protect
Output :

| | |
|---|---|
| Encrypted | = TDES(M,K, K′)=DES(DES⁻¹(DES(M,K),K′),K) |
| message C | |
| | = PTDES(M,K,K′,N1,NRtoP) |

Start :

(20) C=PDES1(M,K,N1,NRtoP) [DES protected according to the
invention : algorithm PDES1]
(21a) C=DES⁻¹(C,K′) [conventional DES⁻¹ without protection]
Alternatively :
(21b) C=PDES1⁻¹((C,K′,1,0) [PDES1⁻¹ without protection]
(22) C=PDES1(C, K, N1, NRtoP)
(23) Return C

End

Algorithm PAES1 (Protected AES)

Input Data :
- K : cryptographic key
- M : message to encrypt
- N1 : maximum number of executions of a round
- NRtoP : number of rounds to protect
Output Data :
- Encrypted message C=AES(M,K)=PAES1(M, K, N1, NRtoP)
Start :

(30) K₀=K
(31) Generate N1-1 false keys (K₁, K₂... K_{N1-1})
(32) R₀=M
(33) For i from 1 to 10 do :

(34) If (i ≦ NRtoP) or (i > 10-NRtoP) then

(34.1) n=min(i-1, 10-i);
(34.2) Nᵢ=N1/2ⁿ
(34.3) Rᵢ=PRAES1(Rᵢ₋₁, i, Nᵢ) [Protected Round]

(35) Otherwise

(35.1) Nᵢ=1
(35.2) Rᵢ=PRAES1(Rᵢ₋₁, i, Nᵢ) [Unprotected Round]

(36) C=R₁₀

(37) Return C
End

Algorithm PRAES1 (Protected Round AES)

Input Data :
- keys (K₀, K₁, K₂... K_{N1-1}) or sub-keys of a preceding round
- message Rᵢ₋₁, 16 bytes
- i round number
- Nᵢ : number of executions of a round of rank i
- N1 (Nᵢ with i=1) : maximum number of executions of a round (first and
last)
Output Data :
- Rᵢ=PRAES1(Rᵢ₋₁, i, Nᵢ)
Start :

(40) For C, D two tables of 16 bytes
(41) Generate N1 sub-keys (SK_{i-1,0}, SK_{i-1,1}, SK_{i-1,2}... SK_{i-1,N1-1})
from keys K₀, K₁, K₂... K_{N1-1} or from sub-keys of a preceding round
(42) Generate a random permutation P={p₀... p_{Ni-1}} in the interval
j=[0, Nᵢ-1]
(43) For j from 0 to (Nᵢ-1) do :

| (43.1) | W=Rᵢ₋₁ |
|---|---|
| (43.2) | W=AddRoundKey(W, SK_{i-1,pj}) [Sub-round 1] |
| (43.3) | W=SubByte(W) [Sub-round 2] |
| (43.4) | W=ShiftRow(W) [Sub-round 3] |
| (43.5) | If (i ≠ 10) then [Sub-round 4 of rounds 1 to 9] |
| | W=MixColumn(W) |
| (43.6) | If (i=10) then [Sub-round 4 of the round 10] |

(43.6.1) Generate N1 sub-keys (SK_{10,0}, SK_{10,1},
SK_{10,2}... SK_{10,N1-1}) from keys K₀, K₁, K₂... K_{N1-1}
or from sub-keys of a preceding round
(43.6.2) W=AddRoundKey(W, SK_{10,pj});

(43.7) If pⱼ=0 then C=W
(43.8) If pj ≠ 0 then D=W

(44) Ri=C
(45) Return (Ri)
End

### ANNEX 3 (Integral Part of the Description)

### Embodiments Implementing the Notion of Modularity

Algorithm PDES2 (Protected DES)

Input Data :
- K : Key
- M : message to encrypt
- N1 : maximum number of executions of a round
- NRtoP : number of rounds to protect
Output Data :
- Encrypted message C=DES(M, K)=PDES2(M, K, N1, NRtoP)
Start :

(50) K₀=K
(51) Generate N1-1 false keys (K₁, K₂... K_{N1-1})
(52) M=IP(M)
(53) Split M into two 32-bit blocks L₀ and R₀

L₀=32 most significant bits of M
R₀=32 least significant bits of M

(54) Generate a random mask U₀ of 8 bytes
(55) Split U₀ into two 32-bit blocks U_{0,L} and U_{0,R}
(56) L₀=L₀ XOR U_{0,L}, R₀=R₀ XOR U_{0,R} [Masking]
(57) For i from 1 to 16 do :

(58) If (i ≦ NRtoP) or (i > 16-NRtoP) then

(58.1) n=min(i-1, 16-i)
(58.2) Nᵢ= N1/(2ⁿ)
(58.3) (Lᵢ, Rᵢ, Uᵢ)=PRDES2(Lᵢ₋₁, Rᵢ₋₁, Uᵢ₋₁, i, Nᵢ) [Protected
Round]

(59) Otherwise :

(59.1) Nᵢ=1
(59.2) (Lᵢ, Rᵢ, Uᵢ)=PRDES2(Lᵢ₋₁, Rᵢ₋₁, Uᵢ₋₁, i, Nᵢ)
[Unprotected Round]

(60) L₁₆=L₁₆ XOR U_{16,L}, R₁₆=R₁₆ XOR U_{16,R} [Demasking]
(61) C=IPinverse (R₁₆ | L₁₆)
(62) Return C

End

Algorithm PRDES2 (Protected Round DES)

Notation :
- i : rank of the round processed
- Nᵢ : number of executions of a round of rank i
- N1 (Nᵢ with i=1) : maximum number of executions of a round (first and
last)
Input Data :
- keys (K₀, K₁, K₂... K_{N1-1}) or sub-keys of a preceding round
- pair (L_{i-1,} Rᵢ₋₁)
- random mask Uᵢ₋₁=(U_{i-1,L}, U_{i-1,R})
- i round number
- Nᵢ number of executions
Output Data :
- (Lᵢ, Rᵢ, Uᵢ)=PRDES2(Lᵢ₋₁, Rᵢ₋₁, Uᵢ₋₁, i, Nᵢ)

Start
(70) For C, D, E, F, four tables of 4 bytes
(71) Generate N1 sub-keys (SK_{i,0}, SK_{i,1}, SK_{i,2}... SK_{i,N1-1}) from keys
K₀, K₁, K₂... K_{N1-1} or from sub-keys of a preceding round
(72) Generate a random permutation P={p₀... p_{Ni-1}} in the interval
j=[0, Nᵢ-1]
(73) T_{R}=Rᵢ₋₁, T_{L}=Lᵢ₋₁
(74) W =Rᵢ₋₁
(75) T_{R}= ExpansivePermutation(T_{R}) [Masked Sub-round 1]
(76) For j from 0 to (Nᵢ-1) do :

(76.1) T_{R}=T_{R} XOR SK_{i,pj} [Masked Sub-round 2]
(76.2) T_{R}=T_{R} XOR ExpansivePermutation(U_{i-1,R}) [Demasking]
(76.3) T_{R}=Substitution(T_{R}) [Unmasked Sub-round 3]
(76.4) T_{R}=T_{R} XOR U_{i-1,R} [Masking]
(76.5) If pⱼ=0 then

```
  C=W
  D=T_{R}
```

(76.6) If pⱼ≠ 0 then

```
  E=W
  F=T_{R}
```

(77) D=Permutation(D) XOR T_{L} [Masked Sub-round 4]
(78) Generate a random mask Uᵢ=(U_{i,L}, U_{i,R}) [Change of mask for the
next round]
(79) C=C XOR U_{i,L} XOR U_{i-1,R}, D=D XOR Permutation(U_{i-1,R}) XOR
U_{i,R} XOR U_{i-1,L}
[Correction of the mask]
(80) Lᵢ=C, Rᵢ=D, Uᵢ=U_{i,L}|U_{i,R}
(81) Return (Lᵢ, Rᵢ, Uᵢ)

End

Algorithm PAES2 (Protected AES)

Input Data :
- K : cryptographic key
- M : message to encrypt
- N1 : maximum number of executions of a round
- NRtoP : number of rounds to protect
Output Data :
- Encrypted message C=AES(M,K)=PAES2(M, K, N1, NRtoP)
Start :

(90) K₀=K
(91) Generate N1-1 false keys (K₁, K₂... K_{N1-1})
(92) Generate a random mask U₀ of 16 bytes
(93) R₀=M XOR U₀ [Masking]
(94) For i from 1 to 10 do :

(95) If (i ≦ NRtoP) or (i > 10-NRtoP) then

(95.1) n=min(i-1, 10-i);
(95.2) Nᵢ=N1/(2ⁿ)
(95.3) (Rᵢ, Uᵢ)=PRAES2(Rᵢ₋₁, Uᵢ₋₁, i, Nᵢ) [Protected
Round]

(96) Otherwise

(96.1) Nᵢ=1
(96.2) (Rᵢ, Uᵢ)=PRAES2(Rᵢ₋₁, Uᵢ₋₁, i, Nᵢ) [Unprotected
Round]

(97) C=R₁₀ XOR U₁₀ [Unmasking]

(98) Return C
End

Algorithm PRAES2 (Protected AES round)

Input Data :
- keys (K₀, K₁, K₂... K_{N1-1}) or sub-keys of a preceding round
- message Rᵢ₋₁, 16 octets
- Random mask Uᵢ₋₁
- i round number
- Nᵢ : number of executions of a round de rank i
- N1 (Nᵢ with i=1) : maximum number of executions of a round (first and
last)
Output Data :
- (Rᵢ, Uᵢ)=PRAES2(Rᵢ₋₁, Uᵢ₋₁, i, Nᵢ)
Start :

(100) For C, D two tables of 16 bytes
(101) Generate N1 sub-keys (SK_{i,0}, SK_{i,1}, SK_{i,2}... SK_{i,N1-1}) for round
i, from keys K₀, K₁, K₂... K_{N1-1} or from sub-keys of a preceding
round
(102) Generate a random permutation P={p₀... p_{Ni-1}} in the interval
j=[0, Nᵢ-1]
(103)W=Rᵢ₋₁
(104) For j from 0 to (Nᵢ-1) do :

(104.1) W=AddRoundKey(W, SK_{i,pj}) [Sub-round 1 masked]
(104.2) W=W XOR Uᵢ₋₁ [Unmasking]
(104.3) W=SubByte(W) [Sub-round 2 not masked]
(104.4) W=W XOR Uᵢ₋₁ [Masking]
(104.5) If pⱼ=0 then C=W
(104.6) If pj ≠ 0 then D=W

(105) C=ShiftRow(C) [Sub-round 3 masked]
(106) Generate a random mask Uᵢ of 16 bytes [Change of mask for
the next round]
(106) If (i ≠ 10) then

(106.1) C=MixColumn(C) [Sub-round 4 masked of rounds 1 to
9]
(106.2) C=C XOR Uᵢ XOR MixColumn(ShiftRow(Uᵢ₋₁)
[Correction of the mask]

(107) If (i=10) then [Sub-round 4 of the round 10]

(107.1) Generate N1 sub-keys (SK_{i,0}, SK_{i,1}, SK_{i,2}... SK_{i,N1-1}) for
round 10, from keys K₀, K₁, K₂... K_{N1-1} or sub-keys of a
preceding round
(107.2) W=C XOR Uᵢ XOR ShiftRow(Uᵢ₋₁) [Correction of the
mask]
(107.3) For j from 0 to (Nᵢ-1) do :

(107.3.1) W=AddRoundKey(W, SK_{10,pj}) [Operation on the
masked value]
(107.3.2) If pⱼ=0 then C=W
(107.3.3) If pⱼ ≠ 0 then D=W

(107.4) W=C

(108) Rᵢ=C
(109) Return (Rᵢ, Uᵢ)

End

1. Symmetric encryption process (CP3, CP4) executed by a microcircuit (MCT) to transform a message (M) into an encrypted message (C) from a secret key (K, K₀), comprising a first round (RDA intermediary rounds (RD₂, RDᵢ, RD_{Nr-1}), and a last round (RD_{Nr}),
characterized in that it comprises several executions (N1, N_{Nr}) of the first round and of the last round, respectively from the secret key (K, K₀) and from a first set of false keys (K₁−K_{N1-1}), and a number of executions (N₁), of at least one intermediary round (RD) less than the number of executions (N1, N_{Nr}) of the first and last rounds, respectively from the secret key and from a set of false keys (K₁−K_{Ni-1}) included in the first set of false keys.

2. Process according to claim 1, comprising a second round (RD₂), a next-to-last round (RD_{Nr-1}), and several intermediary rounds (RDᵢ), wherein the first two rounds are executed a greater number of times than the intermediary rounds, and the last two rounds are executed a greater number of times than the intermediary rounds.

3. Process according to one of claims 1 and 2, comprising only one execution of the at least one intermediary round (RDᵢ).

4. Process according to one of claims 1 to 3, comprising:
for a determined number (NRtoP) of rounds successive from the first, a number of round executions of decreasing according to a decreasing rule that is a function of the rank (i) of rounds considered relative to the first round, then
for a determined number (NRtoP) of successive rounds until the last, a number of round executions increasing according to an increasing rule that is a function of the rank of rounds considered relative to the last round.

5. Process according to claim 4, wherein the decreasing rule is of 1/(2ⁿ), n being a parameter of function of rank of rounds considered relative to the first or to the last round.

6. Process according to one of claims 1 to 5, wherein each round comprises sub-rounds (SRD1-SRD4), and wherein the multiple execution of each round comprises the multiple execution of each sub-round of the round.

7. Process according to one of claims 1 to 5, wherein each round comprises sub-rounds (SRD1-SRD4), and wherein the multiple execution of a round comprises the multiple execution of at least one sub-round, and a single execution of at least one other sub-round.

8. Process according to claim 7, wherein the single execution of the sub-round is a single or higher order masked execution.

9. Process according to claim 7, wherein the multiple execution of the sub-round is a single order masked execution.

10. Process according to one of claims 1 to 9, in conformance with the DES, triple DES, or AES specifications.

11. Microcircuit (MCT) configured to execute a symmetric encryption process (CP3, CP4) to transform a message (M) into an encrypted message (C) from a secret key (K, K₀), the process comprising a first round (RDA₁), intermediary rounds (RD₂, RDᵢ, RD_{Nr-1}), and a last round (RD_{Nr}),
characterized in that the microcircuit is configured to execute several times (N1, N_{Nr}) the first round and the last round, respectively from the secret key and from a first set of false keys (K₁−K_{N1-1}), and to execute at least one intermediary round (RDᵢ) a number of times (Nᵢ) less than the number of executions (N1, N_{Nr}) of the first and last rounds, respectively from the secret key and from a set of false keys (K₁−K_{Ni-1}) included in the first set of false keys.

12. Microcircuit according to claim 11, configured to execute the at least one intermediary round (RDᵢ) only once.

13. Microcircuit according to one of claims 11 and 12, configured to execute rounds comprising sub-rounds (SRD1-SRD4), and to execute, during a multiple execution of a round, all the sub-rounds of the round the same number of times.

14. Microcircuit according to one of claims 11 and 12, configured to execute rounds comprising sub-rounds (SRD1-SRD4), and to execute, during a multiple execution of a round, at least one sub-round only once and to execute another sub-round several times.

15. Microcircuit according to one of claim 13 or 14, comprising a modular coprocessor (CPROC) configured to execute individually encryption operations comprised in sub-rounds.
